(19) United States
(12) Patent Application Publication
(10) Pub. No.: US 2012/0239524 A1
(43) Pub. Date: Sep. 20, 2012

(54) Commerce System and Method of Acquiring Product, Assortment, and Pricing Information to Control Consumer Purchasing

(75) Inventors: Kenneth J. Ouimet, Scottsdale, AZ (US); Timothy L. Ouimet, Scottsdale, AZ (US); Erich B. Wilson, San Jose, CA (US); Anthony Fresina, San Francisco, CA (US)

(73) Assignee: MYWORLD, INC., Scottsdale, AZ (US)

(21) Appl. No.: 13/272,916

(22) Filed: Oct. 13, 2011

Related U.S. Application Data
(63) Continuation-in-part of application No. 13/049,800, filed on Mar. 16, 2011.

(51) Int. Cl. G06Q 30/00; G06Q 30/02

(52) U.S. Cl. 705/26.7; 705/26.1

(57) ABSTRACT

A commerce system has retailers offering products for sale. Product information associated with the products is collected by retrieving the product information from a website of the retailer through a consumer computer system and by confirming and updating the product information, including per unit pricing and price multiples, through electronic communication with the consumers while in a store of the retailer. The product information is stored in a database. A website is provided for consumers to create a shopping list with weighted preferences for product attributes. The shopping list is optimized based on the product information in the database and the weighted preferences for the product attributes. The optimized shopping list is made available to the consumer to assist with purchasing decisions. The purchasing decisions within the commerce system are controlled by enabling the consumers to select the products for purchase based on the optimized shopping list.

### CLAIM TO DOMESTIC PRIORITY

The present application is a continuation-in-part of U.S. patent application Ser. No. 13/049,800, filed Mar. 16, 2011, and claims priority to the above application pursuant to 35 U.S.C. §120.

### FIELD OF THE INVENTION

The present invention relates in general to consumer purchasing and, more particularly, to a commerce system and method of acquiring product, assortment, and pricing information to control consumer purchasing.

### BACKGROUND OF THE INVENTION

Economic and financial modeling and planning are commonly used to estimate or predict the performance and outcome of real systems, given specific sets of input data of interest. An economic-based system will have many variables and influences which determine its behavior. A model is a mathematical expression or representation, which predicts the outcome or behavior of the system under a variety of conditions. In one sense, it is relatively easy to review historical data, understand its past performance, and state with relative certainty that past behavior of the system was indeed driven by the historical data. A more difficult task is to generate a mathematical model of the system, which predicts how the system will behave with different sets of data and assumptions.

In its basic form, the economic model can be viewed as a predicted or anticipated outcome of a system defined by a mathematical expression and driven by a given set of input data and assumptions. The mathematical expression is formulated or derived from principles of probability and statistics, often by analyzing historical data and corresponding known outcomes, to achieve a best fit of the expected behavior of the system to other sets of data. In other words, the model should be able to predict the outcome or response of the system to a specific set of data being considered or proposed, within a level of confidence, or an acceptable level of uncertainty.

Economic modeling has many uses and applications. One area in which modeling has been applied is in the retail environment. Grocery stores, general merchandise stores, specialty shops, and other retail outlets face stiff competition for limited consumers and business. Most, if not all, retail stores expend great effort to maximize sales, revenue, and profit. Economic modeling can be an effective tool in helping store owners and managers to forecast and optimize business decisions. Yet, as an inherent reality of commercial transactions, the benefits bestowed on the retailer often come at a cost or disadvantage to the consumer. Maximizing sales and profits for a retailer does not necessarily expand competition and achieve the lowest price for the consumer.

On the other side of the transaction, the consumers are interested in quality, low prices, comparative product features, convenience, and receiving the most value for the money. Economic modeling can also be an effective tool in helping consumers achieve these goals. However, consumers have a distinct disadvantage in attempting to compile models for their benefit. Retailers have ready access to the historical transaction log (T-LOG) sales data, consumers do not. The advantage goes to the retailer. The lack of access to comprehensive, reliable, and objective product information essential to providing effective comparative shopping services restricts the consumer's ability to find the lowest prices, compare product features, and make the best purchase decisions.

For the consumer, some comparative product information can be gathered from various electronic and paper sources, such as online websites, paper catalogs, and media advertisements. However, such product information is sponsored by the retailer and slanted at best, typically limited to the specific retailer offering the product and presented in a manner favorable to the retailer. That is, the product information released by the retailer is subjective and incomplete, i.e., the consumer only sees what the retailer wants the consumer to see. For example, the pricing information may not provide a comparison with competitors for similar products. The product descriptions may not include all product features or attributes of interest to the consumer.

Alternatively, the consumer can visit all retailers offering a particular type of product and record the various prices, product descriptions, and retailer amenities to make a purchase decision. The brute force approach of one person physically traveling to or otherwise researching each retailer for all product information is impractical for most people. Many people do compare multiple retailers, e.g., when shopping online, particularly for high-ticket items. Yet, the time people are willing to spend reviewing product information decreases rapidly with price. Little time is spent reviewing commodity items. In any case, the consumer has limited time to do comparative shopping and mere searching does not constitute an optimization of the purchasing decision. Optimization requires access to data, i.e., comprehensive, reliable, efficient, and objective product information, so the consumer remains hampered in achieving a level playing field with the retailer.

### SUMMARY OF THE INVENTION

A need exists to collect comprehensive, reliable, and objective product information for the benefit of the consumer. Accordingly, in one embodiment, the present invention is a method of controlling a commerce system comprising the steps of collecting product information, storing the product information in a database, providing a website for consumers to create a shopping list with weighted preferences for product attributes, optimizing the shopping list based on the product information in the database and the weighted preferences for the product attributes, providing the optimized shopping list to the consumer to assist with purchasing decisions, controlling the purchasing decisions within the commerce system by enabling the consumers to select products for purchase based on the optimized shopping list, and confirming and updating the product information through electronic communication with the consumer.

In another embodiment, the present invention is a method of controlling a commerce system comprising the steps of collecting product information, storing the product information in a database, generating a shopping list with weighted preferences for product attributes, optimizing the shopping list based on the product information in the database and the weighted preferences for the product attributes, utilizing the optimized shopping list to control purchasing decisions within the commerce system by enabling the consumers to select products for purchase based on the optimized shopping list, and confirming and updating the product information through electronic communication with the consumer.

In another embodiment, the present invention is a method of controlling a commerce system comprising the steps of collecting product information from a retailer by retrieving the product information through an electronic communication medium of the retailer using a consumer electronic communication device, and confirming and updating the product information through electronic communication with the consumer.

In another embodiment, the present invention is a method of controlling a commerce system comprising the steps of generating a shopping list based on product information, and confirming and updating the product information through electronic communication with the consumer.

In another embodiment, the present invention is a computer program product usable with a programmable computer processor having a computer readable program code embodied in a computer usable medium for controlling a commerce system comprising the steps of collecting product information from a retailer by retrieving the product information through an electronic communication medium of the retailer using a consumer electronic communication device, and confirming and updating the product information through electronic communication with the consumer.

### BRIEF DESCRIPTION OF THE DRAWINGS

FIG. 1 illustrates a commerce system which analyzes T-LOG data to generate demand models and executes a business plan in accordance with those demand models;

FIG. 2 illustrates a commercial supply, distribution, and consumption chain controlled by a demand model;

FIG. 3 illustrates commercial transactions between consumers and retailers with the aid of a consumer service provider;

FIG. 4 illustrates an electronic communication network between the consumers and consumer service provider;

FIG. 5 illustrates a computer system operating with the electronic communication network;

FIG. 6 illustrates a consumer profile registration webpage with the consumer service provider;

FIG. 7 illustrates a consumer login webpage for the consumer service provider;

FIG. 8 illustrates a shopping list entered by the consumer into a personal recommendation engine;

FIG. 9 illustrates collecting product information from retailer websites directly by the consumer service provider or indirectly using consumer computers;

FIG. 10 illustrates the optimized shopping list for download onto the consumer cell phone;

FIG. 11 illustrates the consumer on the premises of the retailer in proximity to a product on the optimized shopping list;

FIGS. 12a-12b illustrate confirmation request and product information updates on the consumer cell phone;

FIG. 13 illustrates a job manager to handle collection of product information; and

FIG. 14 illustrates the process of controlling consumer purchasing decisions within a commerce system.

### DETAILED DESCRIPTION OF THE DRAWINGS

The present invention is described in one or more embodiments in the following description with reference to the figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Economic and financial modeling and planning is an important business tool that allows companies to conduct business planning, forecast demand, and optimize prices and promotions to meet profit and/or revenue goals. Economic modeling is applicable to many businesses, such as manufacturing, distribution, wholesale, retail, medicine, chemicals, financial markets, investing, exchange rates, inflation rates, pricing of options, value of risk, research and development, and the like.

In the face of mounting competition and high expectations from investors, most, if not all, businesses must look for every advantage they can muster in maximizing market share and profits. The ability to forecast demand, in view of pricing and promotional alternatives, and to consider other factors which materially affect overall revenue and profitability is vital to the success of the bottom line, and the fundamental need to not only survive but to prosper and grow.

In particular, economic modeling is essential to businesses that face thin profit margins, such as general consumer merchandise and other retail outlets. Many businesses are interested in economic modeling and forecasting, particularly when the model provides a high degree of accuracy or confidence. Such information is a powerful tool and highly valuable to the business. While the present discussion will involve a retailer, it is understood that the system described herein is applicable to data analysis for other members in the chain of commerce, or other industries and businesses having similar goals, constraints, and needs.

A retailer routinely collects T-LOG sales data for most if not all products in the normal course of business. Using the T-LOG data, the system generates a demand model for one or more products at one or more stores. The model is based upon the T-LOG data for that product and includes a plurality of parameters. The values of the parameters define the demand model and can be used for making predictions about the future sales activity for the product. For example, the model for each product can be used to predict future demand or sales of the product at that store in response to a proposed price, associated promotions or advertising, as well as impacts from holidays and local seasonal variations. Promotion and advertising increase consumer awareness of the product.

An economic demand model analyzes historical retail T-LOG sales data to gain an understanding of retail demand as a function of factors such as price, promotion, time, consumer, seasonal trends, holidays, and other attributes of the transaction. The demand model can be used to forecast future demand by consumers as measured by unit sales. Unit sales are typically inversely related to price, i.e., the lower the price, the higher the sales. The quality of the demand model—and therefore the forecast quality—is directly affected by the quantity, composition, and accuracy of historical T-LOG sales data provided to the model.

The retailer makes business decisions based on forecasts. The retailer orders stock for replenishment purposes and selects items for promotion or price discount. To support good decisions, it is important to quantify the quality of each forecast. The retailer can then review any actions to be taken based on the accuracy of the forecasts on a case-by-case basis.

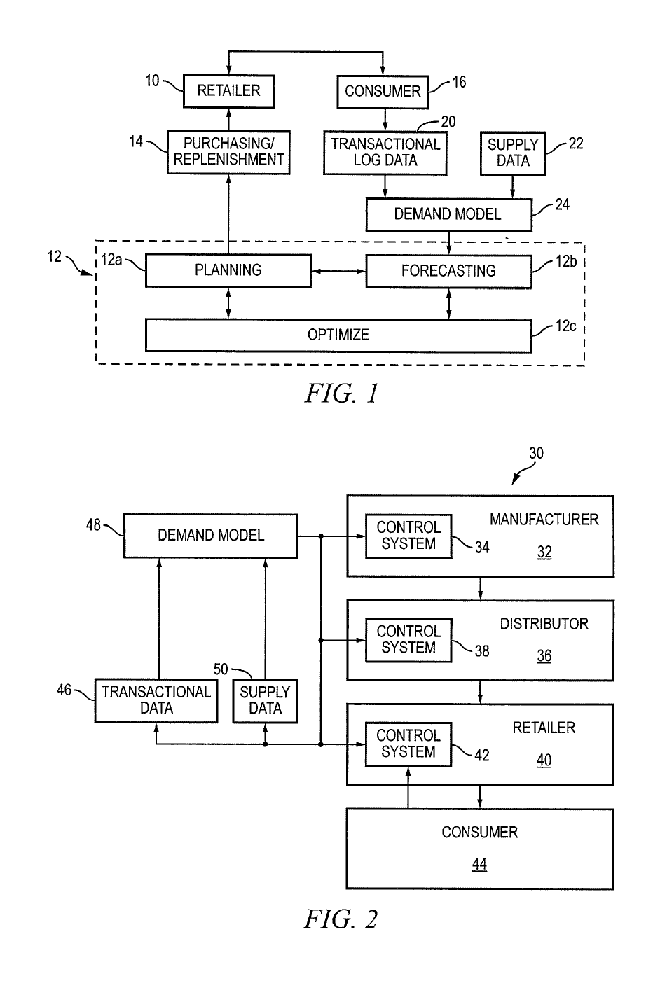

Referring to FIG. 1, retailer 10 has certain product lines or services available to consumers as part of its business plan 12. The terms “products” and “services” are interchangeable in the commercial system. Retailer 10 can be a food store chain, general consumer product retailer, drug store, discount warehouse, department store, apparel store, specialty store, or service provider. Retailer 10 has the ability to set pricing, order inventory, run promotions, arrange its product displays, collect and maintain historical sales data, and adjust its strategic business plan.

Business plan 12 includes planning 12a, forecasting 12b, and optimization 12c steps and operations. Business plan 12 gives retailer 10 the ability to evaluate performance and trends, make strategic decisions, set pricing, order inventory, formulate and run promotions, hire employees, expand stores, add and remove product lines, organize product shelving and displays, select signage, and the like. Business plan 12 allows retailer 10 to analyze data, evaluate alternatives, run forecasts, and make decisions to control its operations. With input from the planning 12a, forecasting 12b, and optimization 12c steps and operations of business plan 12, retailer 10 undertakes various purchasing or replenishment operations 14. Retailer 10 can change business plan 12 as needed.

Retailer 10 routinely enters into sales transactions with customer or consumer 16. In fact, retailer 10 maintains and updates its business plan 12 to increase the number of transactions (and thus revenue and/or profit) between retailer 10 and consumer 16. Consumer 16 can be a specific individual, account, or business entity.

For each sale transaction entered into between retailer 10 and consumer 16, information describing the transaction is stored in T-LOG 20. When a consumer goes through the check-out at a grocery or any other retail store, each of the items to be purchased is scanned and data is collected and stored by a point-of-sale (POS) system, or other suitable data storage system, in T-LOG 20. The data includes the then current price, promotion, and merchandizing information associated with the product along with the units purchased, and the dollar sales. The date and time, and store and consumer information corresponding to that purchase are also recorded.

T-LOG 20 contains one or more line items for each retail transaction, such as those shown in Table 1. Each line item includes information or attributes relating to the transaction, such as store number, product number, time of transaction, transaction number, quantity, current price, profit, promotion number, and consumer category or type number. The store number identifies a specific store; product number identifies a product; time of transaction includes date and time of day; quantity is the number of units of the product; current price (in US dollars) can be the regular price, reduced price, or higher price in some circumstances; profit is the difference between current price and cost of selling the item; promotion number identifies any promotion associated with the product, e.g., flyer, ad, sale price, coupon, rebate, end-cap, etc.; consumer identifies the consumer by type, class, region, or individual, e.g., discount card holder, government sponsored or under-privileged, volume purchaser, corporate entity, preferred consumer, or special member. T-LOG 20 is accurate, observable, and granular product information based on actual retail transactions within the store. T-LOG 20 represents the known and observable results from the consumer buying decision or process. T-LOG 20 may contain thousands of transactions for retailer 10 per store per day, or millions of transactions per chain of stores per day.

TABLE 1
T-LOG Data

| STORE | PRODUCT | TIME | TRANS | QTY | PRICE | PROFIT | PROMOTION | CONSUMER |
|---|---|---|---|---|---|---|---|---|
| S1 | P1 | D1 | T1 | 1 | 1.50 | 0.20 | PROMO1 | C1 |
| S1 | P2 | D1 | T1 | 2 | 0.80 | 0.05 | PROMO2 | C1 |
| S1 | P3 | D1 | T1 | 3 | 3.00 | 0.40 | PROMO3 | C1 |
| S1 | P4 | D1 | T2 | 4 | 1.80 | 0.50 | 0 | C2 |
| S1 | P5 | D1 | T2 | 1 | 2.25 | 0.60 | 0 | C2 |
| S1 | P6 | D1 | T3 | 10 | 2.65 | 0.55 | PROMO4 | C3 |
| S1 | P1 | D2 | T1 | 5 | 1.50 | 0.20 | PROMO1 | C4 |
| S2 | P7 | D3 | T1 | 1 | 5.00 | 1.10 | PROMO5 | C5 |
| S2 | P1 | D3 | T2 | 2 | 1.50 | 0.20 | PROMO1 | C6 |
| S2 | P8 | D3 | T2 | 1 | 3.30 | 0.65 | 0 | C6 |

The first line item shows that on day/time D1, store S1 has transaction T1 in which consumer C1 purchases one product P1 at $1.50. The next two line items also refer to transaction T1 and day/time D1, in which consumer C1 also purchases two products P2 at $0.80 each and three products P3 at price $3.00 each. In transaction T2 on day/time D1, consumer C2 has four products P4 at price $1.80 each and one product P5 at price $2.25. In transaction T3 on day/time D1, consumer C3 has ten products P6 at $2.65 each, in his or her basket. In transaction T1 on day/time D2 (different day and time) in store S1, consumer C4 purchases five products P1 at price $1.50 each. In store S2, transaction T1 with consumer C5 on day/time D3 (different day and time) involves one product P7 at price $5.00. In store S2, transaction T2 with consumer C6 on day/time D3 involves two products P1 at price $1.50 each and one product P8 at price $3.30.

Table 1 further shows that product P1 in transaction T1 has promotion PROMO1. PROMO1 can be any suitable product promotion such as a front-page featured item in a local advertising flyer. Product P2 in transaction T1 has promotion PROMO2 as an end-cap display in store S1. Product P3 in transaction T1 has promotion PROMO3 as a reduced sale price. Product P4 in transaction T2 on day/time D1 has no promotional offering. Likewise, product P5 in transaction T2 has no promotional offering. Product P6 in transaction T3 on day/time D1 has promotion PROMO4 as a volume discount for 10 or more items. Product P7 in transaction T1 on day/time D3 has promotion PROMO5 as a $0.50 rebate. Product P8 in transaction T2 has no promotional offering. A promotion may also be classified as a combination of promotions, e.g., flyer with sale price, end-cap with rebate, or individualized offer as described below.

Retailer 10 may also provide additional information to T-LOG 20 such as promotional calendar and events, holidays, seasonality, store set-up, shelf location, end-cap displays, flyers, and advertisements. The information associated with a flyer distribution, e.g., publication medium, run dates, distribution, product location within flyer, and advertised prices, is stored within T-LOG 20.

Supply data 22 is also collected and recorded from manufacturers and distributors. Supply data 22 includes inventory or quantity of products available at each location in the chain of commerce, i.e., manufacturer, distributor, and retailer. Supply data 22 includes product on the store shelf and replenishment product in the retailer's storage area.

With T-LOG 20 and supply data 22 collected, various suitable methods or algorithms can be used to analyze the data and form demand model 24. Model 24 may use a combination of linear, nonlinear, deterministic, stochastic, static, or dynamic equations or models for analyzing T-LOG 20 or aggregated T-LOG data and supply data 22 and making predictions about consumer behavior to future transactions for a particular product at a particular store, or across entire product lines for all stores. Model 24 is defined by a plurality of parameters and can be used to generate unit sales forecasting, price optimization, promotion optimization, markdown/clearance optimization, assortment optimization, merchandize and assortment planning, seasonal and holiday variance, and replenishment optimization. Model 24 has a suitable output and reporting system that enables the output from the model to be retrieved and analyzed for updating business plan 12.

In FIG. 2, a commerce system 30 is shown involving the movement of goods between members of the system. Manufacturer 32 produces goods in commerce system 30. Manufacturer 32 uses control system 34 to receive orders, control manufacturing and inventory, and schedule deliveries. Distributor 36 receives goods from manufacturer 32 for distribution within commerce system 30. Distributor 36 uses control system 38 to receive orders, control inventory, and schedule deliveries. Retailer 40 receives goods from distributor 36 for sale within commerce system 30. Retailer 40 uses control system 42 to place orders, control inventory, and schedule deliveries with distributor 26. Retailer 40 sells goods to consumer 44. Consumer 44 patronizes retailer's establishment either in person or using online ordering. The consumer purchases are entered into control system 42 of retailer 40 as T-LOG data 46.

The purchasing decisions made by consumer 44 drives the manufacturing, distribution, and retail portions of commerce system 30. More purchasing decisions made by consumer 44 for retailer 40 leads to more merchandise movement for all members of commerce system 30. Manufacturer 32, distributor 36, and retailer 40 utilize demand model 48 (similar to model 24), via respective control systems 34, 38, and 42, to control and optimize the ordering, manufacturing, distribution, sale of the goods, and otherwise execute respective business plan 12 within commerce system 30 in accordance with the purchasing decisions made by consumer 44.

Manufacturer 32, distributor 36, and retailer 40 provide historical T-LOG 46 and supply data 50 to demand model 48 by electronic communication link, which in turn generates forecasts to predict the need for goods by each member and control its operations. In one embodiment, each member provides its own historical T-LOG data 46 and supply data 50 to demand model 48 to generate a forecast of demand specific to its business plan 12. Alternatively, all members can provide historical T-LOG data 46 and supply data 50 to demand model 48 to generate composite forecasts relevant to the overall flow of goods. For example, manufacturer 32 may consider a proposed price, rebate, promotion, seasonality, or other attribute for one or more goods that it produces. Demand model 48 generates the forecast of sales based on available supply and the proposed price, consumer, rebate, promotion, time, seasonality, or other attribute of the goods. The forecast is communicated to control system 34 by electronic communication link, which in turn controls the manufacturing process and delivery schedule of manufacturer 32 to send goods to distributor 36 based on the predicted demand ultimately determined by the consumer purchasing decisions. Likewise, distributor 36 or retailer 40 may consider a proposed price, rebate, promotion, or other attributes for one or more goods that it sells. Demand model 48 generates the forecast of demand based on the available supply and proposed price, consumer, rebate, promotion, time, seasonality, and/or other attribute of the goods. The forecast is communicated to control system 38 or control system 42 by electronic communication link, which in turn controls ordering, distribution, inventory, and delivery schedule for distributor 36 and retailer 40 to meet the predicted demand for goods in accordance with the forecast.

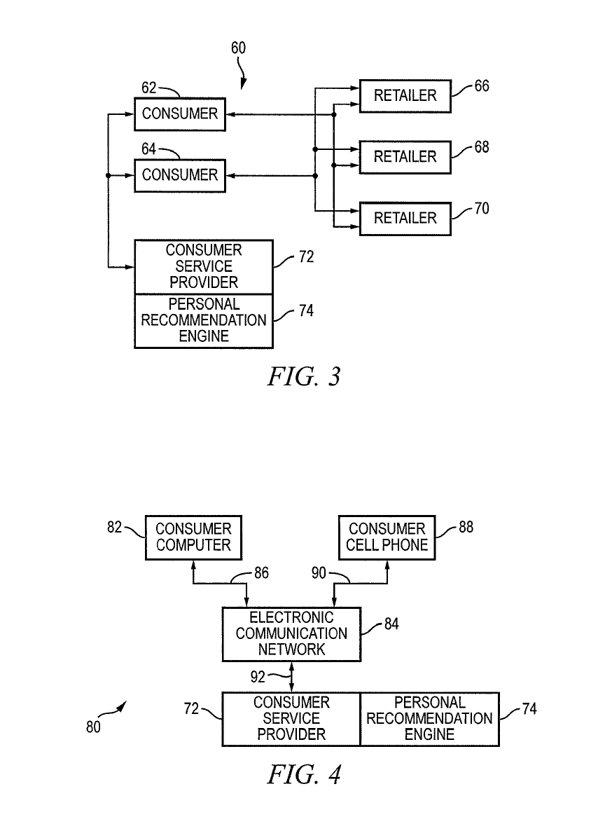

FIG. 3 illustrates a commerce system 60 with consumers 62 and 64 engaged in purchasing transactions with retailers 66, 68, and 70. Retailers 66-70 are supplied by manufacturers and distributors, as described in FIG. 2. Retailers 66-70 are typically local to consumers 62-64, i.e., retailers that the consumers will likely patronize. Retailers 66-70 can also be remote from consumers 62-64 with transaction handled by electronic communication medium, e.g., phone or online website via personal computer, and delivered electronically or by common carrier, depending on the nature of the goods. Consumers 62-64 patronize retailers 66-70 either in person in the retailer's store or by electronic communication medium to select one or more items for purchase from one or more retailers. For example, consumer 62 can visit the store of retailer 66 in person and select product P1 for purchase. Consumer 62 can contact retailer 68 by phone or email and select product P2 for purchase. Consumer 64 can browse the website of retailer 70 using a personal computer and select product P3 for purchase. Accordingly, consumers 62-64 and retailers 66-70 can engage in regular commercial transactions within commerce system 60.

Each consumer goes through a product evaluation and purchasing decision process each time a particular product is selected for purchase. Some product evaluations and purchasing decision processes are simple and routine. For example, when consumer 62 is conducting weekly shopping in the grocery store, the consumer sees a needed item or item of interest, e.g., canned soup. Consumer 62 may have a preferred brand and flavor of canned soup. Consumer 62 selects the preferred brand and flavor sometimes without consideration of price, places the item in the basket, and moves on. The product evaluation and purchasing decision process can be almost automatic and instantaneous but nonetheless still occurs based on prior experiences and preferences. Consumer 62 may pause during the product evaluation and purchasing decision process and consider other canned soup options. Consumer 62 may want to try a different flavor or another brand offering a lower price. As the price of the product increases, the product evaluation and purchasing decision process usually becomes more involved. If consumer 62 is shopping for a major appliance, the product evaluation and purchasing decision process may include consideration of several manufacturers, visits to multiple retailers, review of features and warranty, talking to salespersons, reading consumer reviews, and comparing prices. In any case, understanding the consumer's approach to the product evaluation and purchasing decision process is part of an effective model or comparative shopping service. The model must assist the consumer in finding the optimal price and product attributes, e.g., brand, quality, quantity, size, features, ingredients, service, warranty, and convenience, that are important to the consumer and tip the purchasing decision toward selecting a particular product and retailer.

In FIG. 3, consumer service provider 72 is a part of commerce system 60. Consumer service provider 72 is a third party that assists consumers 62-64 with the product evaluation and purchasing decision process by providing access to an optimization model or comparative shopping service. Consumer service provider 72 works with consumers 62-64 and retailers 66-70 to control commercial transactions within commerce system 60 by optimizing the selection of products by price and other attributes. More specifically, consumer service provider 72 operates and maintains personal recommendation engine 74 that prioritizes product attributes and optimizes product selection according to the consumer's preferences. The personal recommendation engine 74 saves the consumer considerable time and money by providing access to a comprehensive, reliable, and objective optimization model or comparative shopping service.

The personal recommendation engine 74 can be made available to consumers 62-64 via computer based online website or other electronic communication medium, e.g., wireless cell phone or other personal communication device. FIG. 4 shows an electronic communication network 80 for transmitting information between the consumers and consumer service provider 72. Consumer 82 operating with a computer is connected to electronic communication network 84 by way of communication channel or link 86. Likewise, consumer 88 operating with a cellular telephone or other wireless communication device is connected to electronic communication network 84 by way of communication channel or link 90. The electronic communication network 84 is a distributed network of interconnected routers, gateways, switches, and servers, each with a unique internet protocol (IP) address to enable communication between individual computers, cellular telephones, electronic devices, or nodes within the network. In one embodiment, electronic communication network 84 is a global, open-architecture network, commonly known as the Internet. Communication channels 86 and 90 are bi-directional and transmit data between consumers 82 and 88 and electronic communication network 84 in a hard-wired or wireless configuration. For example, consumer 82 can have a computer with email, texting, and Internet capability, and consumer 88 can operate a cellular phone with email, texting, and Internet capability.

The electronic communication network 80 further includes consumer service provider 72 with personal recommendation engine 74 in electronic communication with network 84 over communication channel or link 92. Communication channel 92 is bi-directional and transmits data between consumer service provider 72 and electronic communication network 84 in a hard-wired or wireless configuration.

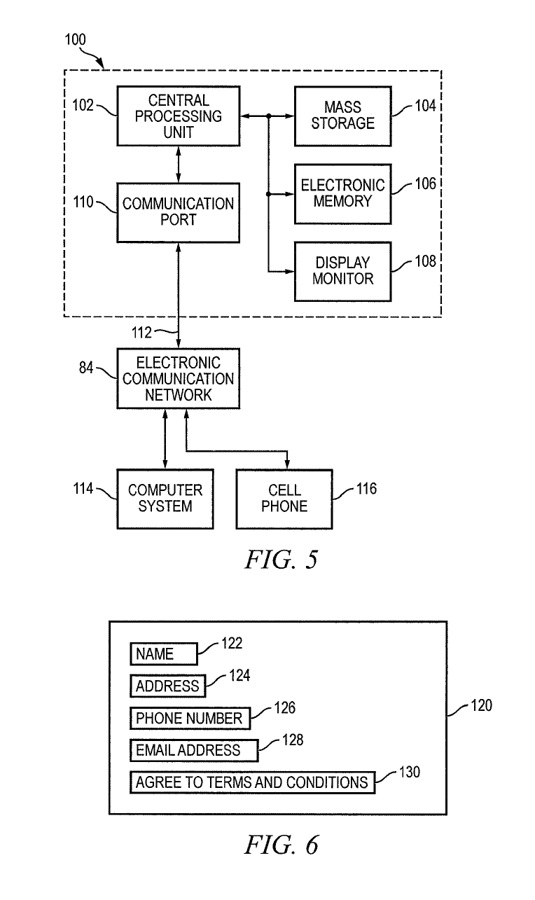

Further detail of the computer systems used in electronic communication network 80 is shown in FIG. 5 as a simplified computer system 100 for executing the software program used in the electronic communication process. Computer system 100 is a general purpose computer including a central processing unit or microprocessor 102, mass storage device or hard disk 104, electronic memory 106, display monitor 108, and communication port 110. Communication port 110 represents a modem, high-speed Ethernet link, wireless, or other electronic connection to transmit and receive input/output (I/O) data over communication link 112 to electronic communication network 84. Computer system or server 114 can be configured as shown for computer 100. Computer system 114 and cellular telephone 116 transmit and receive information and data over communication network 84.

Computer systems 100 and 114 can be physically located in any location with access to a modem or communication link to network 84. For example, computer 100 or 114 can be located in the consumer's home or business office. Consumer service provider 72 may use computer system 100 or 114 in its business office. Alternatively, computer 100 or 114 can be mobile and follow the user to any convenient location, e.g., remote offices, consumer locations, hotel rooms, residences, vehicles, public places, or other locales with electronic access to electronic communication network 84. The consumer can access consumer service provider 72 by mobile application operating in cell phone 116.

Each of the computers run application software and computer programs, which can be used to display user interface screens, execute the functionality, and provide the electronic communication features as described below. The application software includes an Internet browser, local email application, word processor, spreadsheet, and the like. In one embodiment, the screens and functionality come from the application software, i.e., the electronic communication runs directly on computer system 110 or 114. Alternatively, the screens and functions are provided remotely from one or more websites on servers within electronic communication network 84.

The software is originally provided on computer readable media, such as compact disks (CDs), external drive, or other mass storage medium. Alternatively, the software is downloaded from electronic links, such as the host or vendor website. The software is installed onto the computer system hard drive 104 and/or electronic memory 106, and is accessed and controlled by the computer's operating system. Software updates are also electronically available on mass storage medium or downloadable from the host or vendor website. The software, as provided on the computer readable media or downloaded from electronic links, represents a computer program product containing computer readable program code embodied in a computer program medium. Computers 100 and 114 run application software for executing instructions for communication between consumers 82 and 88 and consumer service provider 72, gathering product information, and generating consumer models or comparative shopping services. The application software is an integral part of the control of purchasing decisions within commerce system 60.

The electronic communication network 80 can be used for a variety of business, commercial, personal, educational, and government purposes or functions. For example, consumer 82 using computer 114 can communicate with consumer service provider 72 operating on computer 100, and consumer 88 using cellular telephone 116 can communicate with consumer service provider 72 operating on computer 100. The electronic communication network 80 is an integral part of a business, commercial, professional, educational, government, or social network involving the interaction of people, processes, and commerce.

To interact with consumer service provider 72, the consumer first creates an account and profile with the consumer service provider. The consumer can use some features offered by consumer service provider 72 without creating an account, but full access requires completion of a registration process. The consumer accesses website 120 operated by consumer service provider 72 on computer system 100 and provides data to complete the registration and activation process, as shown in FIG. 6. The consumer can access website 120 using computer 114 or cellular telephone 116 by typing the uniform resource locator (URL) for website 120, or by clicking on a banner located on another website which re-directs the consumer to a predetermined landing page for website 120. The data provided by the consumer to consumer service provider 72 may include name in block 122, address with zip code in block 124, phone number in block 126, email address in block 128, and other information and credentials necessary to establish a profile and identity for the consumer. The consumer's address and zip code are important as shopping is often a local activity. The consumer agrees to the terms and conditions of conducting electronic communication through consumer service provider 72 in block 130.

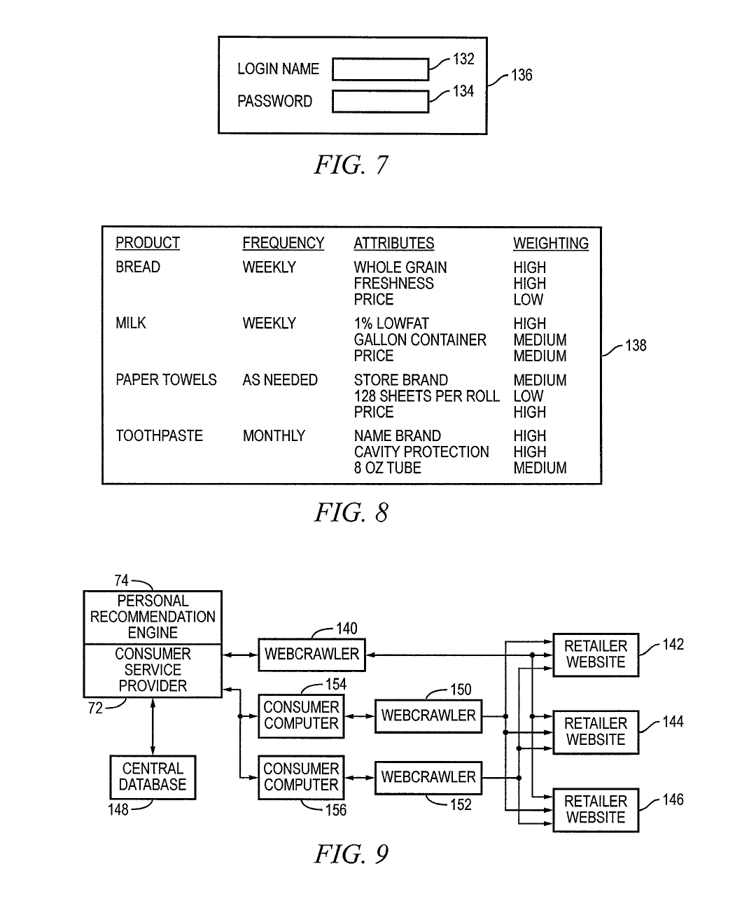

The consumer's profile is stored and maintained within consumer service provider 72. The consumer can access and update his or her profile or interact with personal recommendation engine 74 by entering login name 132 and password 134 in webpage 136, as shown in FIG. 7. The consumer name can be any name, nickname, number, or email address that uniquely identifies the consumer and the password can be assigned to or selected by the consumer. Accordingly, the consumer's profile and personal data remains secure and confidential within consumer service provider 72. Once logged in, the consumer can change personal information, update the profile, access personal incentives and other offers, and otherwise interact with personal recommendation engine 74.

One feature of personal recommendation engine 74 is webpage 138, as shown in FIG. 8, which allows the consumer to enter a list of products of interest or need, i.e., to create a shopping list. In webpage 138, the consumer can enter commonly purchased or anticipated purchase products, such as bread, milk, paper towels, and toothpaste. Each product will have a frequency of purchase, e.g., daily, weekly, monthly, or as needed, and product attributes weighted by consumer preference. The consumer defines the products and weighted preferences. For example, bread is purchased weekly and the consumer preference is whole grain (high importance), freshness (high importance), and price (low importance). Milk is purchased weekly and the consumer preference is 1% low fat (high importance), gallon container (medium importance), and price (medium importance). Paper towels are purchased as needed and the consumer preference is store brand (medium importance), 128 sheet rolls (low importance), and price (high importance). Toothpaste is purchased monthly and the consumer preference is name brand (high importance), cavity protection (high importance), and 8 oz tube (medium importance). The product attribute weighting can be numerical, such as a sliding scale of 0 (lowest importance) to 9 (highest importance).

The consumer can also identify a specific preferred retailer based on convenience and personal experience. The consumer may assign value to shopping with a specific retailer because of specific products offered by that store, familiarity with the store layout, good consumer service experiences, or location that is convenient on the way home from work, picking up the children from school, or routine weekend errand route.

Personal recommendation engine 74 stores the shopping list and weighted product attributes of each specific consumer for future reference and updating. The individual products in the shopping list can be added or deleted and the weighted product attributes can be changed by the consumer. The shopping list entered into personal recommendation engine 74 is specific for each consumer and allows consumer service provider 72 to track specific products and preferred retailers selected by the consumer. Consumer service provider 72 can also present offers available to the consumer, as described below.

When the consumer is ready to go shopping, personal recommendation engine 74 executes a consumer model to optimize the shopping list and determine which products should be purchased from which retailers on which day to maximize the value to the consumer as defined by the consumer profile and list of products of interest with weighted attributes from webpage 138.

In order to generate the consumer model or comparative shopping service, personal recommendation engine 74 must have access to comprehensive, reliable, and objective retailer product information, as well as retailer information such as name, address, hours of operation, assortment of products, planogram, and promotions. The retailer product information is combined with the consumer's profile and list of products of interest or need with weighted attributes from webpage 138 to generate an optimized shopping list. In one approach, retailers 66-70 may grant access to T-LOG data for use by personal recommendation engine 74. As noted in the background, retailers may be reluctant to grant access to T-LOG data, particularly without quid pro quo. However, as personal recommendation engine 74 gains acceptance and the consumer relies on the optimized shopping list to make purchase decisions, retailer 66-70 will be motivated to participate. That is, retailers 66-70 will want to show up as the recommended source for as many products as possible on the optimized shopping list. Primarily, a particular retailer will be the optimized product source when the combination of price and product attributes offered by the retailer aligns with, or provides maximum value in accordance with, the consumer's profile and shopping list with weighted preferences.

One or more retailers 66-70 may decline to provide access to its T-LOG data for use with personal recommendation engine 74. In such cases, consumer service provider 72 can exercise a number of alternative data gathering approaches and sources. In one embodiment, consumer service provider 72 utilizes computer based webcrawlers or other searching software to access retailer websites for pricing and other product information. In FIG. 9, webcrawler 140 operates within the software of computer 100 or 114 used by consumer service provider 72. Consumer service provider 72 dispatches webcrawler 140 to make requests for product information from websites 142, 144, and 146 of retailers 66, 68, and 70, respectively. Webcrawler 140 collects and returns the product information to personal recommendation engine 74 for storage within a central database 148. For example, webcrawler 140 identifies products available from each of retailer websites 142-146 and requests pricing and other product information for each of the identified products. Webcrawler 140 navigates and parses each page of retailer websites 142-146 to locate pricing and other product information. The parsing operation involves identifying and recording product description, universal product code (UPC), price, ingredients, size, and other product information as recovered by webcrawler 140 from retailer websites 142-146. The product information and retailer information from retailer websites 142-146 is sorted and stored in central database 148.

Consumer service provider 72 can also dispatch webcrawlers 150 and 152 from computers 154 and 156 used by consumers 62-64, or from consumer cell phone 116, or other electronic communication device, to access and request product information from retailer websites or portals 142-146 or other electronic communication medium or access point. During the registration process of FIG. 6, consumer service provider 72 acquires the IP address of consumer computers 154 and 156, as well as the permission of the consumers to utilize the consumer computer and login to access retailer websites 142-146. Consumer service provider 72 causes webcrawlers 150 and 152 to be dispatched from consumer computers 154 and 156 and uses the consumer login to retailer websites 142-146 to access and request product information from retailers 66-70. Webcrawlers 150 and 152 collect the product information from retailer websites 142-146 through the consumer computer and login and return the product information to personal recommendation engine 74 for storage within central database 148. The execution of webcrawlers 150-152 from consumer computers 154-156 distributes the computational work.

For example, the consumer logs into the website of consumer service provider 72 via webpage 136. Consumer service provider 72 initiates webcrawler 150 in the background of consumer computer 154 with a sufficiently low execution priority to avoid interference with other tasks running on the computer. The consumer can also define the time of day and percent or amount of personal computer resources allocated to the webcrawler. The consumer can also define which retailer websites and products, e.g., by specific retailer, market, or geographic region, that can be accessed by the webcrawler using the personal computer resources. Webcrawler 150 executes from consumer computer 154 and uses the consumer's login to gain access to retailer websites 142-146. Alternatively, webcrawler 150 resides permanently on consumer computer 154 and runs periodically. Webcrawler 150 identifies products available from each of retailer websites 142-146 and requests pricing and other product information for each of the identified products. Webcrawler 150 navigates and parses each page of retailer websites 142-146 to locate pricing and other product information. The parsing operation involves identifying and recording product description, UPC, price, ingredients, size, and other product information as recovered by webcrawler 150 from retailer websites 142-146. The product information and retailer information from retailer websites 142-146 is sorted and stored in central database 148.

Likewise, webcrawler 152 uses consumer computer 156 and login to gain access to retailer websites 142-146. Webcrawler 152 identifies products available from each of retailer websites 142-146 and requests pricing and other product information for each of the identified products. Webcrawler 152 navigates and parses each page of retailer websites 142-146 to locate pricing and other product information. The parsing operation involves identifying and recording product description, UPC, price, ingredients, size, and other product information as recovered by webcrawler 152 from retailer websites 142-146. The product information and retailer information from retailer websites 142-146 is sorted and stored in central database 148. The product information can be specific to the consumer's login. Retailers 66-70 are likely to accept product information requests from webcrawlers 150-152 because the requests originate from consumer computers 154-156 by way of the consumer login.

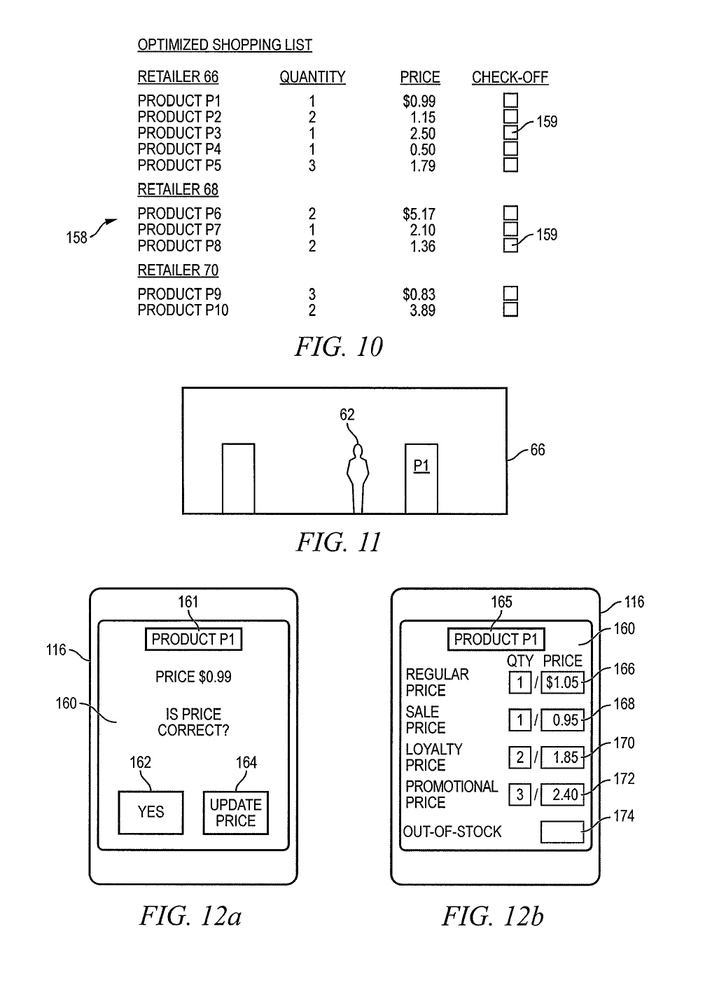

With the retailer product information collected and stored in central database 148, personal recommendation engine 74 generates an optimized shopping list 158, as shown in FIG. 10, by considering each line item of the consumer's shopping list from webpage 138 and reviewing retailer product information in the central database to determine how to best align each item to be purchased with the available products from the retailers. Assume consumer 62 wants to purchase bread and has provided weighted product attributes that are important to his or her purchasing decision. The product attributes of each bread product for retailers 66-70 in central database 148 are compared to the consumer-defined weighted product attributes in the consumer's shopping list by personal recommendation engine 74. For example, the available bread products from retailer 66 are retrieved and compared to the weighted attributes of consumer 62. Likewise, the available bread products from retailer 68 are retrieved and compared to the weighted attributes of consumer 62, and the available bread products from retailer 70 are retrieved and compared to the weighted attributes of consumer 62.

Consumer 62 wants whole-grain bread with a high importance. Bread products that are whole grain are given a high score in accordance with the attribute weight and bread products that are not whole grain are given a low score. Consumer 62 wants fresh bread with a high importance. Bread products that are delivered within a short time of the consumer visit are given a high score in accordance with the attribute weight and bread products that are delivered a longer time before the consumer visit are given a low score. Consumer 62 wants a low price bread with a low importance. Bread products that are low cost relative to other similar bread products are given a high score in accordance with the attribute weight and bread products that are higher cost relative to other similar bread products are given a low score.

The weighted scores for each product attribute defined by the consumer are combined and a specific bread product from a specific retailer that comes closest to matching the consumer-defined weighted product attributes, i.e., the product with the highest score, is selected as the optimized product for the line item. In one embodiment, the weighted scores for the product attributes are summed. Personal recommendation engine 74 may determine that bread and milk should be purchased from retailer 66 on Monday to take advantage of the beginning of the week fresh product delivery and likelihood of plentiful stock. Paper towels should be purchased from retailer 68 before Wednesday based on current sale or promotional pricing. Toothpaste should be purchased from retailer 70 because retailers 66 and 68 do not carry the name brand preferred by the consumer. Retailers 66-70 are matched to the consumer's locale for convenience based on the profile information.

Retailers 66-70 can enhance their relative position and provide support for consumer service provider 72 by making T-LOG data available to consumer service provider 72. One way to get a high score when comparing retailer product attributes to the consumer-defined weighted product attributes is to ensure that personal recommendation engine 74 has access to the most accurate and up-to-date retailer product attributes via central database 148. Even though a given retailer may have a desirable product attribute, personal recommendation engine 74 cannot record a high score if it does not have complete information about the retailer's product attribute. By giving consumer service provider 72 direct access to T-LOG data, the retailer makes the product information readily available to personal recommendation engine 74 which will hopefully increase its score and provide more occurrences of the retailer as the recommended source for as many products as possible on the optimized shopping list. While the use of webcrawlers in FIG. 9 is effective in gathering product information from retailer websites, direct access to retailer T-LOG data and retailer information, such as name, address, hours of operation, assortment of products, planogram, and promotions, will further aid the consumers in generating the optimized shopping list. The promotional information from retailers includes minimums and maximums on quantity of products purchased, dates, related product discounts (discount on product P1 requires purchase of product P2), and other qualifiers.

Retailers 66-70 can also enhance their relative position and provide support for consumer service provider 72 by offering discounts, special offers, or other rewards to consumers through personal recommendation engine 74. By utilizing personal recommendation engine 74, retailers 66-70 are not just randomly distributing a discount offer, e.g., as with mailbox flyers and coupons, with hope that a consumer might purchase a product from the retailer based on the discount. By teaming with consumer service provider 72, retailers 66-70 are reaching a targeted audience that has already acknowledged a need for the product by creating the shopping list via website 138. The discounted offer from retailers 66-70 can be customized for the consumer who is likely to buy or at least has expressed interest in the product. Retailers 66-70 will pay a premium to know that their advertising dollar is going directly to a likely-to-buy consumer who will also receive an objective and optimized recommendation to purchase from a trusted source, i.e., personal recommendation engine 74. Retailers 66-70 will have reached the consumer at or near the tipping point in the purchasing decision process. Consumer service provider 72 receives revenue or other compensation from retailers 66-70 by accepting special pricing for the retailers available through personal recommendation engine 74. Consumer service provider 72 may also receive access to T-LOG data from retailers 66-70 in general support of personal recommendation engine 74 or as part of its compensation.

The consumer patronizes retailers 66-70 with optimized shopping list 158 from personal recommendation engine 74 in hand and makes purchasing decisions based on the recommendations on the optimized shopping list. The consumers can rely on personal recommendation engine 74 as having produced a comprehensive, reliable, and objective shopping list in view of the consumer's profile and weighted product preferences, as well as retailer product information, that will yield the optimal purchasing decision to the benefit of the consumer. Personal recommendation engine 74 helps consumers quantify and develop confidence in making a good decision to purchase a particular product from a particular retailer. While the consumer makes the decision to place the product in the basket for purchase, he or she comes to rely upon or at least consider the recommendations from consumer service provider 72, i.e., optimized shopping list 158 contributes to the tipping point for consumers to make the purchasing decision. The consumer model generated by personal recommendation engine 74 thus in part controls many of the purchasing decisions and other aspects of commercial transactions within commerce system 60.

As another technique of collecting product information, consumer service provider 72 works with consumers 62-64 to gather product information directly from in-store activities. The optimized shopping list 158 can be downloaded onto the consumer's cell phone or other wireless communication device for easy reference while shopping, see cell phone 116 in FIG. 5. For example, the optimized shopping list 158 directs consumer 62 to retailer 66 for products P1-P5, retailer 68 for products P6-P8, and retailer 70 for products P9-P10, as shown in FIG. 10. A similar optimized shopping list is downloaded or otherwise provided to consumer 64.

Consider an example of consumer 62 patronizing the store of retailer 66 with optimized shopping list 158. FIG. 11 shows consumer 62 physically on the premises of retailer 66 proximate to product P1. Consumer 62 finds product P1 and places the item in the basket for purchase. Since the purchasing decision has been made, consumer 62 checks off product P1 from optimized shopping list 158 on cell phone 116, see check box 159 of FIG. 10. The check-off of product P1 can be pressing a key on the cell phone keypad or touching the proper location on a touch-screen display of the cell phone. The check-off can also be accomplished by scanning the UPC of product P1. Many cell phones 116 are capable of scanning the UPC by taking a picture of the barcode and transmitting the picture to consumer service provider 72 for decoding. An application on cell phone 116 can also decode the barcode into the UPC. The check-off of product P1 on cell phone 116 automatically sends a message or otherwise notifies consumer service provider 72 in realtime that consumer 62 is presently proximate to product P1 on the premises of retailer 66 and has made the decision to purchase the product.

Consumer service provider 72 checks central database 148 to determine if the price or other information related to product P1 needs to be updated. The product price is the most common attribute to change, although other product information, e.g., package size, ingredients, and features, may require confirmation from time to time. For example, the determination to confirm product pricing depends on the type of product, length of time since the last update, and market conditions. Some products are historically stable in price. Other products change regularly in price with manufacturing and distribution disruptions, currency fluctuations, weather, seasonality, or other market conditions. If the price of product P1 has not been updated for one or two weeks, then consumer service provider 72 requests a price confirmation. If the market for product P1 is dynamic, as noted by frequent price changes, then daily or weekly updates may be indicated. If a product has been recently confirmed, then a confirmation request for that product is deferred for a period of time determined by the historically price stability of the product.

If the price of product P1 needs updating, consumer service provider 72 sends a request to consumer 62 to confirm or validate the price of product P1. The confirmation request appears as a popup window on display 160 of cell phone 116 with a confirmation request containing current product information and pricing of product P1 according to central database 148, as shown in FIG. 12a. An image of product P1, including brand, size, and other product attributes, can be displayed in block 161 for ready identification and confirmation of the product with consumer 62. The present regular price for retailer 66 according to central database 148 is displayed as $0.99 with a request to confirm the regular price. Display 160 can also show present sale price, loyalty price, or promotion price in per unit pricing or price multiples. Consumer visually compares the price(s) of product P1 in the confirmation request with the in-store price of retailer 66. If the confirmation request price on cell phone 116 is the same as the in-store price, then consumer 62 confirms the price by pressing “yes” button 162. Consumer service provider 72 records the confirmed price in central database 148. The confirmation request can also show the named consumer, with appropriate permissions, that last confirmed or updated the product P1.

If the confirmation request price on cell phone 116 is different from the in-store price, i.e., there is a price discrepancy between retailer 66 and central database 148, then consumer 62 presses “update price” button 164. An image of product P1, including brand, size, and other product attributes, can be displayed in block 165 for ready identification and confirmation of the product with consumer 62. Price update windows 166-172 are displayed on cell phone 116, as shown in FIG. 12b. Consumer 62 can indicate that the in-store price of product P1 is a regular price, sale price, loyalty price, and/or promotional price so that central database 148 will have a point of reference for any price update. Central database 148 maintains a plurality of prices for each product and each retailer, including the regular price, sale price, loyalty price, and promotional price. The pricing can be presented as a per unit price, i.e. $1.05 for one product P1, or price multiples, e.g. 2 for $1.85 or buy two get one free.

In one case, consumer notes that the present in-store price in retailer 66 is a new regular price of $1.05. Consumer 62 enters the regular per unit price (default condition) of 1 for $1.05 in price update window 166. The updated pricing for product P1 is transmitted to consumer service provider 72, which in turn records the price change in central database 148. The QTY window is a default value 1 for per unit pricing. The updated price from consumer 62 is stored within central database 148 as the new regular price for product P1 in retailer 66.

In another case, consumer notes that the present in-store price in retailer 66 is a new sale price of $0.95. A sale price is a temporary price reduction available to all consumers. Consumer 62 enters the per unit sale price of 1 for $0.95 in price update window 168. The updated pricing for product P1 is transmitted to consumer service provider 72, which in turn records the price change in central database 148. The updated price from consumer 62 is stored within central database 148 as the new sale price for product P1 in retailer 66.

In another case, consumer notes that the present in-store price in retailer 66 is a new loyalty price multiple of 2 for $1.85. A loyalty price is a temporary price reduction available to consumers registered with or otherwise belonging to the retailer's loyalty program, e.g., carrying a retailer loyalty card. A price multiple is a temporary price reduction for purchasing multiple units of products P1. In another example, a price multiple can be an offer to buy a certain number of product P1 at regular price and get additional units free, e.g., buy 3 and get 1 free. Consumer 62 enters the loyalty price multiple of 2 in the QTY window and $1.85 in price update window 170. The updated pricing for product P1 is transmitted to consumer service provider 72, which in turn records the price change in central database 148. The updated price from consumer 62 is stored within central database 148 as the new loyalty price for product P1 in retailer 66.

In another case, consumer notes that the present in-store price in retailer 66 is a new promotional price multiple of 3 for $2.40. A promotional price is a temporary price reduction available to all consumers or a group of consumers. A price multiple is a temporary price reduction for purchasing multiple units of products P1. In another example, a price multiple can be an offer to buy a certain number of product P1 at regular price and get additional units free, e.g., buy 3 and get 1 free. Consumer 62 enters the promotional price multiple of 3 in the QTY window and $2.40 in price update window 172.

The updated pricing for product P1 is transmitted to consumer service provider 72, which in turn records the price change in central database 148. The updated price from consumer 62 is stored within central database 148 as the new promotional price for product P1 in retailer 66.

Consumer 62 can also note an out-of-stock condition in retailer 66. If no product P1 is on the shelf, and consumer 62 confirms with store personnel that no product P1 is stored in the backroom, the consumer can click the out-of-stock condition or status in window 174. The out-of-stock condition for product P1 is transmitted to consumer service provider 72, which in turn records the product status for retailer 66 in central database 148. Consumer service provider 72 can respond to the out-of-stock status for product P1 in retailer 66 by transmitting to consumer 66 other retailers that show stock available.

Consumer service provider 72 typically does not ask consumer 62 to confirm the price of every product on optimized shopping list 158. In one embodiment, consumer 62 may be asked to confirm a limited number of products, e.g., 10% of the items, on optimized shopping list 158. Alternatively, consumer 62 may be asked to confirm no more than a predetermined number of items during a period of time, e.g., no more than five confirmation requests during a given week. The confirmation of product information is distributed among a large number of people in the consumer community utilizing personal recommendation engine 74, i.e., other consumers are asked to confirm other products. The workload is uniformly and fairly distributed among the consumer community without undue inconvenience or burden to any one consumer.

Consumer service provider 72 can use price zones, assortment zones, promotion zones, and price families to minimize the number of price updates that need to be validated by consumer 62. A price zone is a group of retail stores that have the same regular price for a product. An assortment zone is a group of retail stores that have the same product assortment. A promotion zone is a group of retail stores that have the same promotion for a product. A price family is a group of products that have the same regular and promotional price.

Consumer service provider 72 may transmit a confirmation request to more than one consumer for a given product at a given retailer in a given period of time. Consumer 62 may make an error in the confirmation request, e.g., misinterpret the product information or make a data entry error on cell phone 116. For example, if a first consumer responds with a price change for product P1 at retailer 66, then a second consumer may receive a confirmation request for the same product P1 at retailer 66 in order to confirm the price change. Central database 148 can hold the price change as pending until verified by the second consumer. Once the second consumer confirms the price change, then the new price is recorded in central database 148 for use in optimizing shopping lists for other consumers. The redundancy of collecting the same price updates from multiple consumers negates or reduces human error in the confirmation process and ensures the accuracy of the product information in central database 148.

In another embodiment, the optimized shopping list 158 is tagged with specific confirmation requests at the time of download to cell phone 116. As the consumer checks off products that are tagged for confirmation, a confirmation request popup window similar to FIG. 12a is automatically displayed on cell phone 116 for consumer 62 to act upon. Consumer 62 confirms the price or other product information for the tagged product and transmits the information to consumer service provider 72.

The consumer may of course decline the confirmation request, e.g., if time does not permit for the additional task. The robustness and accuracy of the system is based on a multitude of consumers contributing to the product information updates so occasional omissions have negligible impact.

On the other hand, consumer 62 may choose to be proactive and confirm every product on optimized shopping list 158 in exchange for a reward for the extra effort, such as a special offer, price reduction on future purchases, or cash back reward. In another proactive example, consumer 62 can scan the UPC code of a product not on optimized shopping list 158 by taking a photo of the barcode and sending the photo to consumer service provider 72. The barcode is decoded to the specific product. If consumer service provider 72 determines that the product needs a price confirmation, then the price confirmation window is sent to consumer 62, similar to FIG. 12b. Consumer 62 completes the price confirmation form and receives a reward for the extra effort.

The process of checking off each product from optimized shopping list 158 constitutes a check-in for that product in that consumer service provider 72 will receive confirmation that consumer 62 is on the premises of retailer 66 and making the purchasing decision for the product. The product check-in gives retailers valuable feedback as to time, location, and consumer demographics associated with purchasing decisions on a product-by-product basis. The product price confirmation and update, as described for FIGS. 12a-12b, also can be used as a check-in for the product. Consumer 62 can be incentivized with special offers, price reductions on future purchases, or cash back reward for participating in the product check-in.

Many cell phones contain a global positioning system (GPS) capability. Consumer service provider 72 can be automatically notified by cell phone 116 that consumer 62 is presently on the premises of retailer 66 using GPS. Consumer service provider 72 can send needed price confirmation requests, again a subset of the items on optimized shopping list 158, to consumer 62 while he or she is conveniently in the store. Consumer 62 has the option to respond to the price confirmation requests. Consumer 62 is incentivized to reply to the price confirmation request with special offers, price reductions on future purchases, or cash back reward.

The reward for contributions to the in-store product information confirmation can take the form of social status. Top contributors can be listed by name, with appropriate consumer permission, on webpage 138 for all registered consumers to see. People will recognize and appreciate that their friends and neighbors are doing their part and more for the benefit of the consumer community. Alternatively, consumer 62 can receive a message on cell phone 116 that another named consumer has already confirmed the price so they don't have to perform the task. Human nature appreciates name recognition.

The consumer can give feedback to consumer service provider 72 that optimized shopping list 158 was indeed used and helpful to make purchasing decisions. For example, consumer 62 can provide comments or testimonials, which are posted on the consumer service provider website. Consumers often place importance on the comments of other consumers, which build confidence and credibility in the benefits of personal recommendation engine 74 and optimized shopping list 158. Consumer service provider 72 can also send out questionnaires or surveys to the registered consumers asking confirmation of products actually purchased based on optimized shopping list 158, or inquiring as to the usefulness of personal recommendation engine 74, or soliciting recommendations for the consumer model or comparative shopping service.

The purchasing decisions actually made by consumers 62-64 while patronizing retailers 66-70 can be reported back to consumer service provider 72. Upon completing the check-out process, the consumer is provided with an electronic receipt of the purchases made. The electronic receipt is stored in cell phone 116, downloaded to personal assistant engine 74, and stored in central database for comparison to optimized shopping list 144. The product information in central database 148 can be updated from the electronic receipt. That is, the actual prices for the products on optimized shopping list 144 as charged by the retailer can be confirmed and updated as indicated.

Consumer 62 can also request comparative product pricing from cell phone 116 while on the premises of retailer 66. For example, consumer 62 can use cell phone 116 to take a photo of the bar code for a selected product, not necessarily on optimized shopping list 158. The photo is sent to consumer service provider 72 and decoded to a specific product, which is searched in central database 148. Consumer service provider 72 returns a list of retailers with the best pricing for the selected product. Consumer 62 can decide to purchase the selected product in retailer 66, or defer the purchase to a retailer with better pricing.

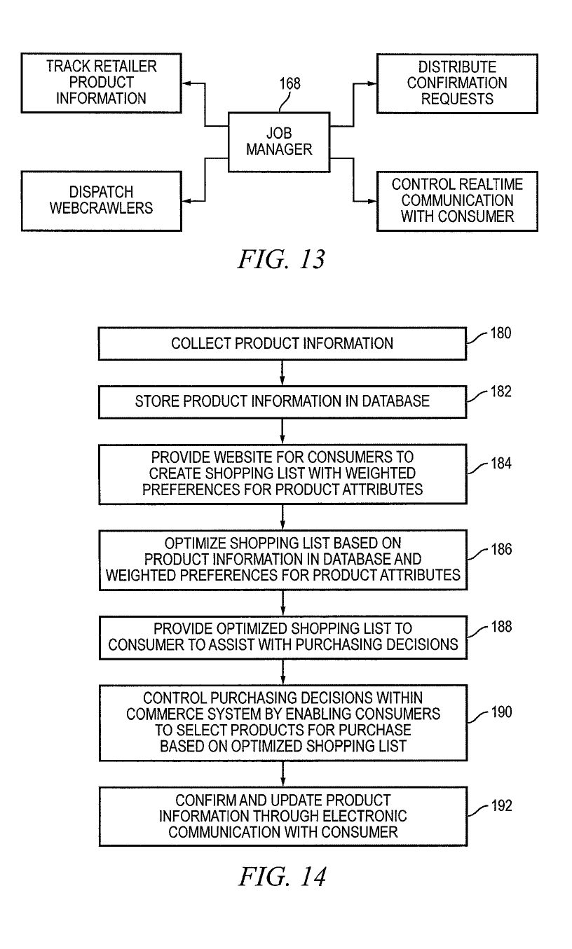

Consumer service provider 72 maintains a job manager 178 in FIG. 13 to distribute confirmation requests between the consumers. Job manager 178 monitors central database 148 and determines timing and distribution of confirmation requests for product pricing and other product information. Job manager 178 queues the confirmation requests to particular consumers that have the product needing confirmation on their optimized shopping list. Job manager 178 controls realtime communication with consumers 62-64 via cell phone 116 during consumer visits to the retail store to conduct price confirmations for central database 148.

Job manager 178 also tracks retailer product information and prioritizes webcrawlers 140, 150, and 152 to queue up requests from consumer computers 154 and 156 to retailer websites 142-146. That is, not every webcrawler 140, 150, and 152 will search every retailer for every product. The workload is distributed by job manager 178 to avoid redundancy and minimize product information requests made to retailer websites 142-146. For example, job manager 178 may task webcrawler 150 to serially parse 100 products on retailer website 142. Job manager 178 also tasks webcrawler 152 to serially parse 100 products on retailer website 144. The workload is distributed among the numerous consumer computers to minimize impact on the retailers as well as the consumers. The product information retrieval jobs sent to retailer websites 142-146 can be queued sequentially or in parallel.

Retailers can also make effective use of consumer service provider 72. Many retailers will want to know what consumers are seeing and doing. By compiling a sample shopping list containing a strategic cross-section of products using personal recommendation engine 74, the retailer will know how many times it is named as the optimized source or how many times the competitor is named as the optimized source on a product-by-product basis. With support of consumer service provider 72, the retailer can use the product information on central database 148 to run its own demand models or even demand models based on competitors' data in accordance with the description of FIG. 1. The more information that the retailer can analyze, the greater the potential market share and profitability that can be achieved. The strategic scenarios that can be executed with the product information on central database 148 will encourage the retailers to share T-LOG data with consumer service provider 72, which will enhance the data bandwidth of the system and may lead competitors to do the same.

The revenue model for consumer service provider 72 can involve dealing in competitive pricing data for retailers. Consumer service provider 72 can also offer targeted advertising through personal recommendation engine 74. Retailers 66-70 can reach a targeted audience that has already acknowledged a need for the product by creating the shopping list via website 138. The discounted offer from retailers 66-70 is customized for the consumer who is likely to buy or at least has expressed interest in the product. Retailers 66-70 will pay a premium to know that their advertising dollar is going directly to a likely-to-buy consumer who will also receive an objective and optimized recommendation to purchase from a trusted source, i.e., personal recommendation engine 74. Retailers 66-70 will have reached the consumer at or near the tipping point in the purchasing decision process. Consumer service provider 72 receives revenue or other compensation from retailers 66-70 by accepting special pricing for the retailers available through personal recommendation engine 74.

FIG. 14 illustrates a process for controlling a commerce system including a plurality of retailers offering products for sale. In step 180, product information associated with the products is collected by retrieving the product information from a website of the retailer through a consumer computer system. Collecting the product information can involve retrieving the product information from a retailer website, or retrieving the product information from a retailer website through a consumer computer system as defined by the consumer. The consumer can establish a consumer account with a consumer service provider and store login information for a retailer website with the consumer service provider. Consumer computer execution time and resources can be allocated for collecting the product information as defined by the consumer. The product information can be received directly from the retailers. A job manager handles the collection of the product information. In step, 182, the product information is stored in a database. In step 184, consumers use the consumer service provider website to create a shopping list with weighted preferences for product attributes. In step 186, the shopping list is optimized based on the product information in the database and the weighted preferences for the product attributes. In step 188, the optimized shopping list is made available to the consumer to assist with purchasing decisions. In one embodiment, the optimized shopping list is downloaded to the consumer cell phone for easy reference during the shopping trip. In step 190, the purchasing decisions within the commerce system are controlled by enabling the consumers to select products for purchase based on the optimized shopping list. In step 192, the product information is confirmed and updated through electronic communication with the consumer while in a place of business of the retailer. The products purchased based on the optimized shopping list are checked off and, if needed, confirmed and updated upon check off of the products purchased based on the optimized shopping list. The consumer can be prompted to update the product information through electronic communication, e.g., by cell phone, while in the place of business of the retailer. The consumer can indicate that the update relates to regular price, sale price, loyalty price, or promotional price, in terms of per unit pricing or price multiples. An out-of-stock condition for the product can be recorded through electronic communication with the consumer. The number of price update requests made of the consumer is a limited number of products on the optimized shopping list. Data can be collected on the consumer use of the optimized shopping list in order to provide incentives or rewards to the consumers based on utilization of the optimized shopping list.

In summary, the consumer service provider in part controls the movement of goods between members of the commerce system. The personal recommendation engine offers consumers economic and financial modeling and planning, as well as comparative shopping services, to aid the consumer in making purchase decisions by optimizing the shopping list according to consumer-weighted preferences for product attributes. The optimized shopping list requires access to retailer product information. The consumer service provider uses a variety of techniques to gather product information from retailer websites and in-store product checks made by the consumer. The optimized shopping list helps the consumer to make the purchasing decision based on comprehensive, reliable, and objective retailer product information. The consumer makes purchases within the commerce system based on the optimized shopping list and product information compiled by the consumer service provider. By following the recommendations from the consumer service provider, the consumer can receive the most value for the money. Where retailers historically have an advantage over consumers with control of the T-LOG data and economic modeling to optimize profits, the consumer service provider has leveled the playing field by optimizing the purchasing decision within the commerce system for the benefit of the consumer.

While one or more embodiments of the present invention have been illustrated in detail, the skilled artisan will appreciate that modifications and adaptations to those embodiments may be made without departing from the scope of the present invention as set forth in the following claims.

What is claimed:

1. A method of controlling a commerce system, comprising:
collecting product information;
storing the product information in a database;
providing a website for consumers to create a shopping list with weighted preferences for product attributes;
optimizing the shopping list based on the product information in the database and the weighted preferences for the product attributes;
providing the optimized shopping list to the consumer to assist with purchasing decisions;
controlling the purchasing decisions within the commerce system by enabling the consumers to select products for purchase based on the optimized shopping list; and
confirming and updating the product information through electronic communication with the consumer.

2. The method of claim 1, wherein confirming and updating the product information includes updating regular price, sale price, loyalty price, or promotional price for the product through electronic communication with the consumer.

3. The method of claim 2, further including updating regular price, sale price, loyalty price, or promotional price based on a price multiple.

4. The method of claim 1, wherein confirming and updating the product information includes recording an out-of-stock condition for the product through electronic communication with the consumer.

5. The method of claim 1, wherein collecting the product information includes retrieving the product information from a retailer website.

6. The method of claim 1, wherein collecting the product information includes receiving the product information from a retailer.

7. A method of controlling a commerce system, comprising:
collecting product information;
storing the product information in a database;
generating a shopping list with weighted preferences for product attributes;
optimizing the shopping list based on the product information in the database and the weighted preferences for the product attributes;
utilizing the optimized shopping list to control purchasing decisions within the commerce system by enabling the consumers to select products for purchase based on the optimized shopping list; and
confirming and updating the product information through electronic communication with the consumer.

8. The method of claim 7, wherein confirming and updating the product information includes updating regular price, sale price, loyalty price, or promotional price for the product through electronic communication with the consumer.

9. The method of claim 8, further including updating regular price, sale price, loyalty price, or promotional price based on a price multiple.

10. The method of claim 7, wherein confirming and updating the product information includes recording an out-of-stock condition for the product through electronic communication with the consumer.

11. The method of claim 7, wherein collecting the product information includes retrieving the product information from a retailer website.

12. The method of claim 7, wherein collecting the product information includes receiving the product information from a retailer.

13. The method of claim 7, further including providing incentives or rewards to the consumers for confirming and updating the product information.

14. A method of controlling a commerce system, comprising:
collecting product information from a retailer by retrieving the product information through an electronic communication medium of the retailer using a consumer electronic communication device; and
confirming and updating the product information through electronic communication with the consumer.

15. The method of claim 14, further including:
storing the product information in a database;
generating a shopping list with weighted preferences for product attributes;
optimizing the shopping list based on the product information in the database and the weighted preferences for the product attributes; and
utilizing the optimized shopping list to control purchasing decisions within the commerce system by enabling the consumers to select products for purchase based on the optimized shopping list.

16. The method of claim 14, wherein confirming and updating the product information includes updating regular price, sale price, loyalty price, or promotional price for the product through electronic communication with the consumer.

17. The method of claim 16, further including updating regular price, sale price, loyalty price, or promotional price based on a price multiple.

18. The method of claim 14, wherein confirming and updating the product information includes recording an out-of-stock condition for the product through electronic communication with the consumer.

19. The method of claim 14, wherein collecting the product information includes retrieving the product information from a retailer website.

20. The method of claim 14, wherein collecting the product information includes receiving the product information from the retailer.

21. The method of claim 14, further including receiving the product information from an electronic receipt.

22. A method of controlling a commerce system, comprising:
generating a shopping list based on product information; and
confirming and updating the product information through electronic communication with the consumer.

23. The method of claim 22, further including:
storing the product information in a database;
generating the shopping list with weighted preferences for product attributes;
optimizing the shopping list based on the product information in the database and the weighted preferences for the product attributes; and
utilizing the optimized shopping list to control purchasing decisions within the commerce system by enabling the consumers to select products for purchase based on the optimized shopping list.

24. The method of claim 22, wherein confirming and updating the product information includes updating regular price, sale price, loyalty price, or promotional price for the product through electronic communication with the consumer.

25. The method of claim 24, further including updating regular price, sale price, loyalty price, or promotional price based on a price multiple.

26. The method of claim 22, wherein confirming and updating the product information includes recording an out-of-stock condition for the product through electronic communication with the consumer.

27. The method of claim 22, further including retrieving the product information from a retailer website.

28. The method of claim 22, further including receiving the product information from the retailer.

29. The method of claim 22, further including receiving the product information from an electronic receipt.

30. A computer program product usable with a programmable computer processor having a computer readable program code embodied in a computer usable medium for controlling a commerce system, comprising:
collecting product information from a retailer by retrieving the product information through an electronic communication medium of the retailer using a consumer electronic communication device; and
confirming and updating the product information through electronic communication with the consumer.

31. The computer program product of claim 30, further including:
storing the product information in a database;
generating a shopping list with weighted preferences for product attributes;
optimizing the shopping list based on the product information in the database and the weighted preferences for the product attributes; and
utilizing the optimized shopping list to control purchasing decisions within the commerce system by enabling the consumers to select products for purchase based on the optimized shopping list.

32. The computer program product of claim 30, wherein confirming and updating the product information includes updating regular price, sale price, loyalty price, or promotional price for the product through electronic communication with the consumer.

33. The computer program product of claim 32, further including updating regular price, sale price, loyalty price, or promotional price based on a price multiple.

34. The computer program product of claim 30, wherein confirming and updating the product information includes recording an out-of-stock condition for the product through electronic communication with the consumer.
